(19) United States
(12) Patent Application Publication
(10) Pub. No.: US 2009/0139199 A1
(43) Pub. Date: Jun. 4, 2009

(54) PULSE DETONATION COMBUSTOR VALVE FOR HIGH TEMPERATURE AND HIGH PRESSURE OPERATION

(75) Inventors: Ross Hartley Kenyon, Waterford, NY (US); Narendra Digamber Joshi, Schenectady, NY (US); Venkat Eswarlu Tangirala, Niskayuna, NY (US); Anthony John Dean, Scotia, NY (US); Adam Rasheed, Glenville, NY (US); Aaron Jerome Glaser, Niskayuna, NY (US); James Fredric Wiedenhoefer, Clifton Park, NY (US); David Chapin, Kansas City, MO (US); Kevin Hinckley, Saratoga Springs, NY (US); Pierre Francois Pinard, Delmar, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 12/271,082

(22) Filed: Nov. 14, 2008

Related U.S. Application Data
(60) Provisional application No. 60/988,171, filed on Nov. 15, 2007.

(51) Int. Cl. F02C 5/12

(52) U.S. Cl. 60/39.39

(57) ABSTRACT

A pulse detonation combustor valve assembly contains at least one pulse detonation combustor having an inlet portion through which air and/or fuel enters the chamber of the combustor. An annular rotating valve portion is positioned adjacent to an outer surface of the pulse detonation combustor and concentrically with the pulse detonation combustor so that the annular rotating valve portion can be rotated with respect to the combustor. The annular rotating valve portion contains at least one inlet portion through which air and/or fuel passes to enter the inlet portion of the pulse detonation combustor.

### PRIORITY

This invention claims priority to U.S. Provisional Application 60/988,171 filed on Nov. 15, 2007, the entire disclosure of which is incorporated herein by reference.

### BACKGROUND OF THE INVENTION

This invention relates to pulse detonation systems, and more particularly, to a pulse detonation combustor for high temperature and high pressure operation.

With the recent development of pulse detonation combustors (PDCs) and engines (PDEs), various efforts have been underway to use PDC/Es in practical applications, such as in aircraft engines and/or as means to generate additional thrust/propulsion. Further, there are efforts to employ PDC/E devices into “hybrid” type engines which use a combination of both conventional gas turbine engine technology and PDC/E technology in an effort to maximize operational efficiency. It is for either of these applications that the following discussion will be directed. It is noted that the following discussion will be directed to “pulse detonation combustors” (i.e. PDCs). However, the use of this term is intended to include pulse detonation engines, and the like.

Because of the recent development of PDCs and an increased interest in finding practical applications and uses for these devices, there is an increasing interest in increasing their operational and performance efficiencies, as well as incorporating PDCs in such a way so as to make their use practical.

In some applications, attempts have been made to replace standard combustion stages of engines with a single PDC. However, it is known that the operation of PDCs creates extremely high pressure peaks and oscillations both within the PDC and upstream components, as well as generating high heat within the PDC tubes and surrounding components. Because of these high temperatures and pressure peaks and oscillations during PDC operation, it is difficult to develop operational systems which can sustain long term exposure to these repeated high temperature and pressure peaks/oscillations.

Further, because of the need to block the pressure peaks from upstream components, various valving techniques are being developed to prevent high pressure peaks from traveling upstream to the compressor stage. However, because of the frequencies, pressures and temperatures experienced from PDC operation the use of traditional valving is insufficient. Inadequate valving can cause unsteady pressure oscillations that can cause less than optimal compressor operation.

Therefore, there exists a need for an improved method of implementing PDCs in turbine based engines and power generation devices, which address the drawbacks discussed above.

### SUMMARY OF THE INVENTION

In an embodiment of the present invention, a pulse detonation combustor valve assembly contains a pulse detonation tube having at least one inlet portion and a rotating valve portion coupled to and concentric with the at least one pulse detonation tube and adjacent to the at least one inlet portion. The rotating valve portion has at least one opening which corresponds to the at least one inlet portion on the pulse detonation tube during rotation of the rotating valve portion.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

As used herein, “engine” means any device used to generate thrust and/or power.

### BRIEF DESCRIPTION OF THE DRAWINGS

The advantages, nature and various additional features of the invention will appear more fully upon consideration of the illustrative embodiment of the invention which is schematically set forth in the figures, in which:

FIGS. 1A through 1C show a diagrammatical representation of an exemplary embodiment of the present invention;

FIG. 2 shows a diagrammatical representation of another exemplary embodiment of the present invention;

FIG. 3 shows a diagrammatical representation of a further exemplary embodiment of the present invention;

FIG. 4 shows a diagrammatical representation of an exemplary implementation of an exemplary embodiment of the present invention;

FIG. 5 shows a diagrammatical representation of another exemplary implementation of an embodiment of the present invention;

FIG. 6 shows a diagrammatical representation of a further exemplary implementation of an embodiment of the present invention;

FIGS. 7A and 7B show a diagrammatical representation of the cross-sections of exemplary embodiments of the present invention;

FIG. 8 shows a diagrammatical representation of an additional exemplary implementation of an embodiment of the present invention; and

FIGS. 9A and 9B shows a diagrammatical representation of a further exemplary embodiment of the present invention.

### DETAILED DESCRIPTION OF THE INVENTION

The present invention will be explained in further detail by making reference to the accompanying drawings, which do not limit the scope of the invention in any way.

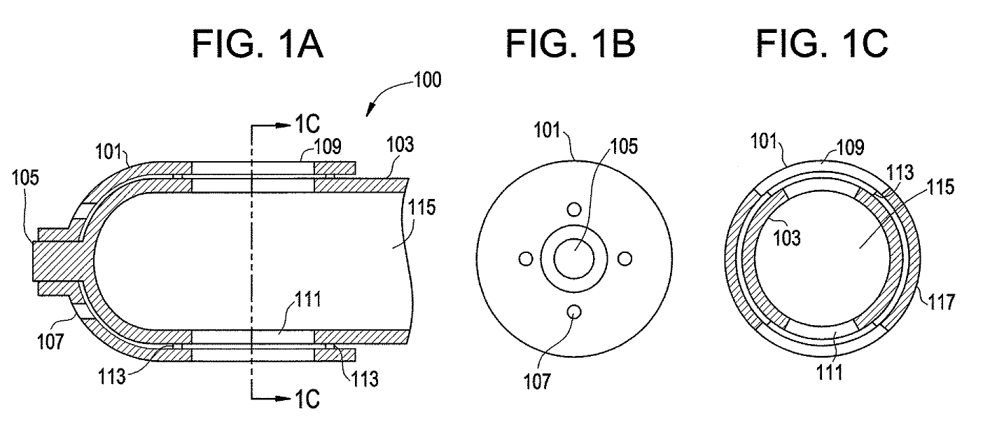

FIGS. 1A through 1C depict a PDC valve assembly 100 in accordance with an exemplary embodiment of the present invention. The valve assembly 100 comprises an annular rotating valve portion 101 that is concentric with a PDC tube 103. Within the PDC tube 103 detonations occur within the chamber 115 to provide thrust and/or work energy out of a downstream end of the tube 103 (not shown). The annular rotating valve portion 101 is positioned concentrically with respect to the tube 103, as shown. During operation, the rotating valve portion 101 is rotated about the outside of the tube 103. In the exemplary embodiment depicted, the tube 103 has a bearing or shaft portion 105 with which the rotating valve portion 101 engages. This can be seen in FIG. 1B, which is an end view looking at the portion 105. As used herein, the expression concentrically is intended to describe a structure in which at least a portion of the tube 103 is within the valve portion 101. For example, as in the embodiments shown, the valve portion 101 is concentric with a portion of the tube 103, in that it is external to the tube 103 and around an entire perimeter of the tube 103.

As shown in each of FIGS. 1A and 1C (which is a cross-section of the assembly 100) the rotating valve portion 101 has at least one inlet portion 109 which corresponds to at least one PDC inlet portion 111. In the exemplary embodiment shown, two inlet portions 109 are depicted. During operation, the rotating valve portion 101 is rotated around the PDC tube 103. During this rotation the inlet portions 109 repeatedly engage with the PDC inlet portions 111. This engagement allows for air flow (or any oxidizer) to pass through the opening portions 109/111 and into the chamber 115 for operation of the PDC tube 103. Thus, during at least the purge and fill stages of PDC operation, the openings 109 and 111 are engaged with each other to allow for the flow of oxidizer and/or fuel into the chamber. Then, as the inlet portion 109 passes the PDC inlet portion 111, the PDC tube 103 and chamber 115 become closed, so that a detonation may occur. Thus, in an exemplary embodiment, during operation the rotational speed of the rotating valve portion 101 is selected such that at the completion of the fill stage, the PDC chamber 115 becomes closed at which time a detonation within the PDC tube 103 occurs. Thus, during detonation, the pressure waves that pass through PDC inlet portion 111 will impact onto the walls 117 of the rotating valve portion 101. In an exemplary embodiment of the present invention, the rotating valve portion 101 is coaxial with the PDC tube 103. Further, in exemplary embodiments of the present invention the centerline of the rotating valve portion 101 is parallel with the centerline of the PDC tube 103.

This exemplary embodiment of the present invention significantly reduces the forces and loads experienced by upstream components, which greatly simplifies operation as well as extending the operational life of the assembly 100. Specifically, some prior art methods of PDC valving includes employing valves axially at an end of the PDC tube. In such an embodiment, the pressure forces push directly against the valving and the repeated oscillations can greatly reduce the service life of the upstream components and structures. This is also true of valving embodiment which are off-center, that is non-concentrially with the PDC tube 103. Similarly, the forces and oscillations generated by the PDC operation significantly diminish the service life of such embodiment because of the uneven loading. This uneven loading requires significant structure to ensure proper operation, and this significant structure is costly.

The concentric configuration of the present invention obviates these issues. As discussed above, because of the concentric configuration of embodiments of the present invention, the forces experienced by the rotating valve portion 101 are radially against its wall structure 117. Very little, if any, forces will be experienced axially (for example, in the upstream direction in FIG. 1A) by the rotating valve portion 101. Therefore, the components coupled to the rotating valve portion 101 (for example, its driving mechanism) will be shielding from the damaging pressure oscillations. The high pressure forces created by the operation of the PDC tube 103 will be effectively captured within the chamber 115, thus shielding upstream components. Further, because the chamber 115 becomes closed during detonation the upstream air supply stage (for example a compressor stage from a typically turbine type engine) will be shielding from pressure fluctuations traveling upstream and thus “un-starting” the air flow (e.g. stalling the compressor).

In the embodiment depicted the inlet portions 111/109 are shown on opposite sides of the PDC tube 103, such that they are positioned 180 degrees from each other. By having such a symmetrical configuration, the reaction forces on the rotating valve portion 101 are effectively balanced. Such a balanced configuration limits the net radial force experienced by the rotating valve portion 101, again decreasing the complexity needed for operation, while extending its operation life.

It is further noted that although two portions 109/111 are shown in each of the rotating valve portion 101 and the tube 103, the present invention is not limited in this regard. Specifically, more than two (e.g., three, four, or more) ports may be used in each of the rotating valve portion 101 and/or tube 103. Further, the shape/configuration/geometry of the portions 109/111 are to be selected based on the needed operational and performance. For example, the portions 109/111 should be of a number, size and shape to ensure proper filling for proper PDC operation.

In the embodiment shown in FIGS. 1A and 1C the inlet portion 109 is larger than the PDC inlet portion 111 to allow for proper flow into the chamber 115. However, the present invention is not limited in this regard as it is contemplated that the inlet portion 109 can be approximately the same size as the PDC inlet portion 111 or smaller, depending on desired operational characteristics.

As shown in FIGS. 1A and 1C, the depicted exemplary embodiment uses seal structures 113 to effectively seal the chamber 115. Specifically, the seals 113 contain the pressure rise within the chamber 115 and prevent the pressure rise from passing to any upstream components. In the embodiment shown, the seals are secured to the outer surface of the PDC tube 103, however, the present invention is not limited in this regard. That is, the seals 113 can be secured to either or both of rotating valve portion 101 and/or the tube 103. Further, the number, type and configuration of the seals 113 are to be selected to ensure that the pressure rise is sufficiently maintained within the chamber 115 of the tube 103. The seals 113 can be aviation type seals, or any known type of seal structure. In an exemplary embodiment, the seals 113 surround the PDC inlet portions 111 to contain the pressure rise. In an alternatively exemplary embodiment the seals 113 can be non-contact type seals. For example, an air gap can be used. In such an embodiment, wear becomes a minimal issue as there is no contact, but some back-flow may occur.

In an exemplary embodiment, the rotating valve portion 101 is rotated by any known means. For example, a motor, belt or chain driven mechanism can be employed. This will be discussed in more detail below. Further, the coupling between the tube 103 and the rotating valve portion 101, at the bearing portion 105, can be of any known configuration. However, the coupling should allow for sufficient restraint of the rotating valve portion 101 on the tube 103 and that the rotating valve portion 101 is free to rotate.

In the above exemplary embodiment, the rotating valve portion 101 rotates around the tube 103. However, in another exemplary embodiment the PDC tube 103 is rotated about its axis within the rotating valve portion 101. In such an embodiment, a motor or other drive mechanism can be coupled to the bearing portion 105 to rotate the tube 103. In a further embodiment, both the rotating valve portion 101 and the tube are rotated. They can be rotated in the same or different directions.

Additionally, depending on the desired operational performance, the rate of rotation of the rotating valve portion 101 and/or the tube 103 can be constant or it can be variable based on various performance and operational requirements. Further, the rotational speed of the components can be changed or adjusted to change the fill profile of the PDC tube 103 to achieve the desired operation. Thus, it is contemplated that the rotational speed of the rotating valve portion 101 and/or the tube 103 can be changed within a single rotation to alter or tailor the fill profile of the PDC tube 103. The rotational speed of the components can be controlled by any known means, such as through the use of a computer control system, stepper motors, and the like. An exemplary embodiment of the present also allows for the rotation to be stopped so that the PDC tube 103 can be operated in a deflagration mode. In such an embodiment, the tube 103 and/or the rotating valve portion 101 are stopped such that the inlet portions 109/111 are aligned as need to provide for sufficient flow into the chamber 115.

In an exemplary embodiment of the present invention, as shown in FIGS. 1A and 1B, ports 107 are positioned on the rotating valve portion 101. The ports 107 allow for the venting of cavity which exists between the rotating valve portion 101 and the tube 103. During operation, it is possible that detonation pressure leaks through out of the tube 103 past the seals 113 into the cavity between the rotating valve portion 101 and the tube 103. If this pressure is allowed to build within this cavity, the pressure can create excessive axial thrust loads on the bearing portion 105, thus reducing the operational life of the system. The presence of the ports 107 allows the internal pressures within the cavity to leak out and minimize the thrust loads on the bearing portion.

In an exemplary embodiment of the invention, the rotating valve portion 101 and the PDC tube 103 are of a structure and strength such that the repeated detonations within the chamber 115 do not alter the structural shape of the components. This ensures proper continuous operation. Although not shown, either or both of the rotating valve portion 101 and the tube 103 can have structural stiffeners on an outer surface thereof, to provide additional strength. Further, the structural stiffeners provide additional surface area for heat dissipation.

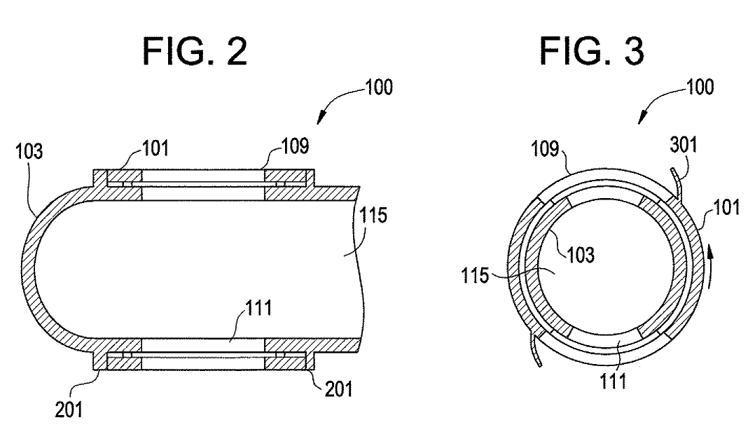

Turning now to FIG. 2 an additional exemplary embodiment of the present invention is shown. In this embodiment, the valve assembly 100 has a different configuration. In this embodiment, the rotating valve portion 101 does not encompass the upstream end of the tube 103 (as shown in FIG. 1A). In this embodiment, the rotating valve portion 101 is positioned between positioning members 201 which prevent the can from translating axially along the tube 103. As with the previous embodiment the seal structure 113 can be of any known type or structure. Specifically, the seal 113 can be bearings mounted to either or both of the rotating valve portion 101 and the tube 103. Further additional bearings can be placed between the positioning members 201 and the rotating valve portion 101.

FIG. 3 depicts another exemplary embodiment of the present invention, in which fins 301 are positioned on an outer surface of the rotating valve portion 101. The fins 301 have a geometry which directs additional flow into the inlet portions 109/111. Thus, as the flow from the air source (such as a compressor) flows over the rotating valve portion 101, an additional amount of flow is directed into the inlet portions 109/111. Further, the fins 301 may be structured to induce a swirling flow into the chamber 115. In an additional exemplary embodiment (not shown) the fins 301 can be angled with respect to the air flow direction and/or have an airfoil shape, to provide a rotational force on the rotating valve portion 101. This would use the flow of air over the fins 301 to spin the rotating valve portion 101 without the need for a motor or external rotational force. Alternatively, the air flow can supplement a rotational drive force.

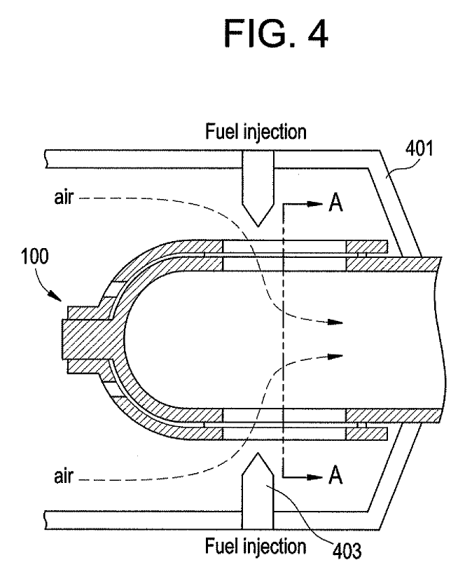

FIG. 4 depicts the valve assembly 100 shown in FIG. 1A within an air and fuel flow scheme. In the embodiment shown the air flow is received from an upstream air source (such as a compressor stage) and is directed to the inlet portions 109/111 via an air flow duct structure 401. This structure 401 directs at least some of the flow from the air source (not shown) into the PDC tube 103. In the embodiment shown, the structure 401 is coupled to the tube 103. However, the present invention is not limited in this regard. Additionally, the shape and configuration of the structure 401 is to be configured to optimize air flow into the inlet portions 109/111.

Coupled to the structure 401 are fuel injectors 403 which inject fuel into the air flow. The fuel injectors 403 can be of any known type and configuration, and the number of injectors may be varied as required. Further, the positioning of the injectors 403 is not limited to that shown in FIG. 4. Specifically, the injectors 403 can be positioned at any location to inject fuel into the air flow prior to detonation within the tube 103. In an exemplary embodiment, the fuel injection can be pulsed to be timed with the opening of the inlet portions 109/111. In this embodiment there is a minimal ore-mixed fuel-air region upstream of the inlet portions 109/111. Additionally, although not shown, it is contemplated that a venturi type structure (providing a venture effect) can be employed near the inlet portions 109/111 to increase the velocity of the air flow into the tube 103. With this accelerated flow, the air flow can assist with the droplet atomization of a liquid fuel in fuel injection type applications.

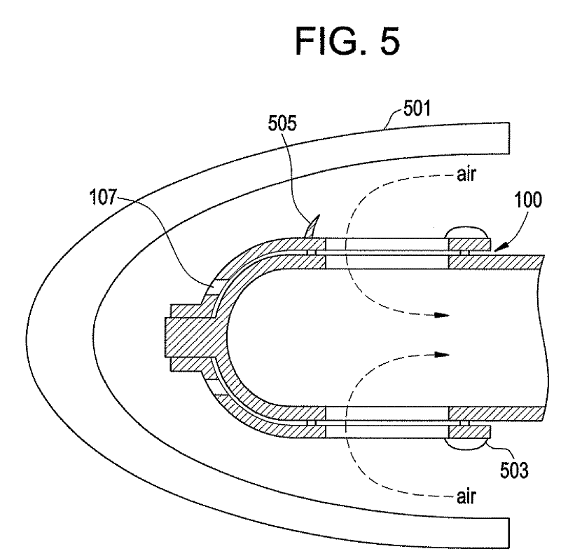

FIG. 5 is another exemplary embodiment of the present invention. In this embodiment, the primary air flow is traveling in an upstream direction prior to entering inlet portions 109/111. The air flow is directed via a flow direction structure 501. The flow direction structure 501 can be shaped as required to direct the flow into the inlet portions 109/111 and the ports 107. In an exemplary embodiment of the present invention, a protrusion 505 may be employed to aid in directing flow into the inlet portions 109/111. Further, another flow protrusion 503 may be employed to aid the air flow in turning into the inlet portions 109/111. The protrusion 503 is of a shape which aids the flow in turning into the inlet portions. Similar to embodiments discussed above, the flow protrusion 503 can be of a shape to provide a rotational force as the air flow passes over the protrusions 503, such as having a twisted or airfoil type shape.

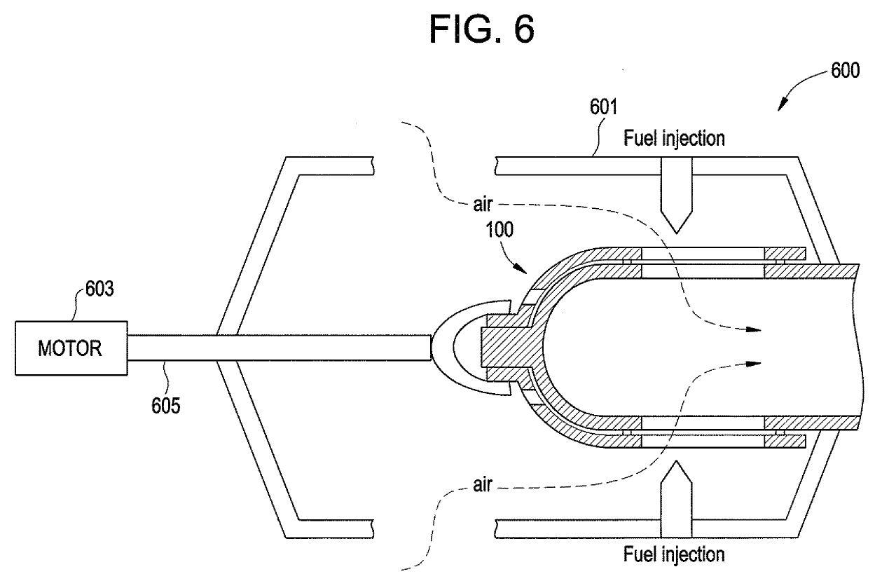

Turning now to FIG. 6, an exemplary embodiment of a valve assembly drive mechanism 600 is shown. In this embodiment, a single valve assembly 100 is placed within a duct structure 601 that directs air flow into assembly, as described above. The duct structure 601 is of a shape to ensure adequate flow into the inlet portions 109/111 of the assembly 100. Coupled to the rotating valve portion 101 of the assembly 100 is a shaft 605. The shaft 605 is coupled to a motor 603 which causes the rotating valve portion 101 to rotate about the tube 103. In the embodiment shown, a direct drive system is used in which the motor 603 is directly coupled to the rotating valve portion 101 via the shaft 605. However, it is also contemplated that gearing may be used, as well as belt or chain drives. The rotation of the rotating valve portion 101 can be controlled as described above.

The shaft 605 can be coupled to the motor 603 and the rotating valve portion 101 (or the PDC tube 103) via any known method. Those of ordinary skill in the art are capable of coupling the components to ensure proper operation.

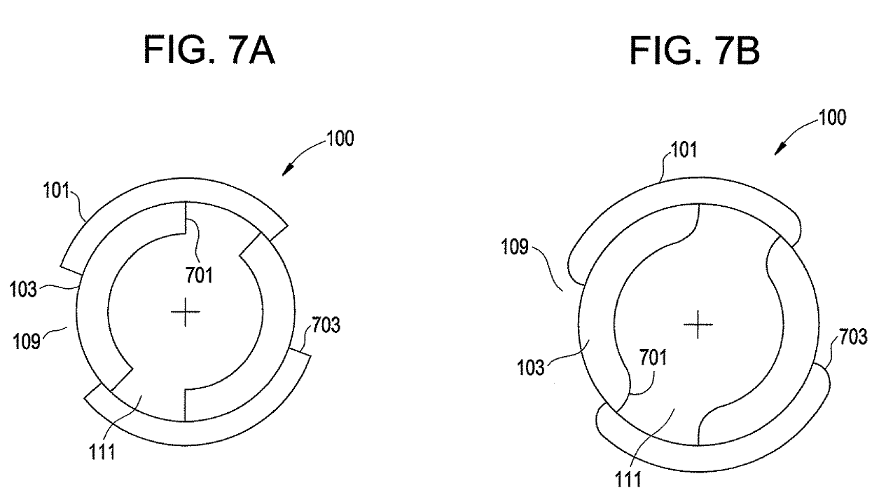

FIGS. 7A and 7B depict cross-sections of alternative embodiments of the present invention. The embodiment shown in FIG. 7A is similar to that shown in FIG. 1C in that the side walls 701 and 703 of the inlet portions 111 and 109, respectively are straight line side walls. In the embodiment shown, the side walls 701/703 are made radially in line with the centerline of the assembly 100. However, the present invention is not limited to this embodiment. The side walls 701/703 can be angled or shaped so as to optimize flow into the PDC tube 103 during operation in order to minimize pressure losses. For example, FIG. 7B shows another exemplary embodiment of the present invention. In this embodiment, the side walls 701/703 are curved rather than straight. This curved contour of the side walls 701/703 results in a reduced pressure drop in the air flow as it passes through the inlet portions 109/111.

The overall shape and size of the inlet portions are to be optimized based on design and performance parameters.

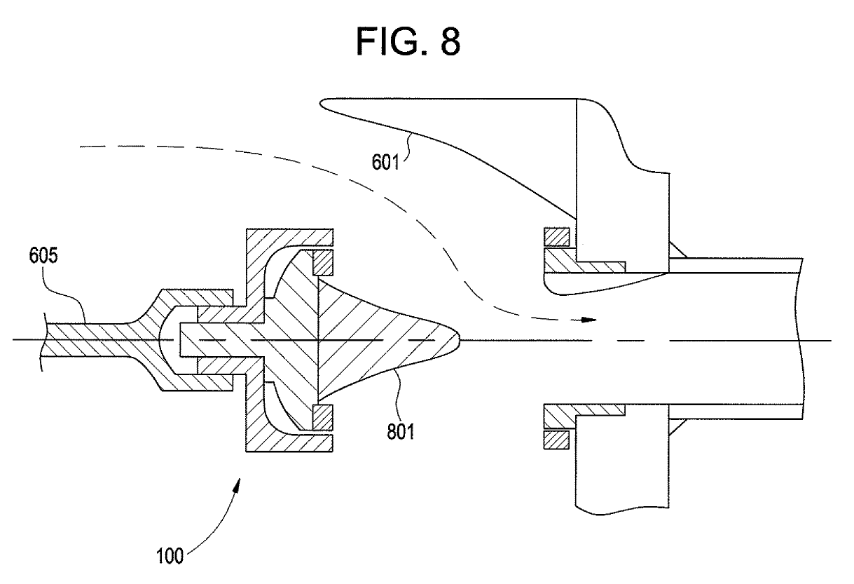

FIG. 8 shows another exemplary embodiment of the present invention. In this embodiment, within the PDC tube 103 a contoured inlet cone 801 is positioned at the upstream end of the tube 103. The cone 801 is contoured to allow for the air flow to enter the PDC tube 103 with minimum pressure drop. The exact shape and contour of the cone 801 is to be optimized based on design and performance characteristics.

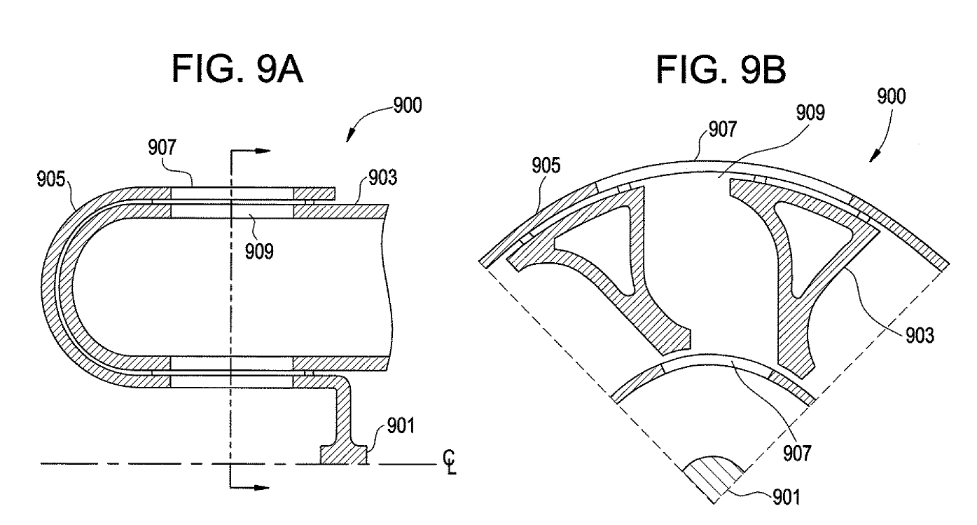

It is noted that the above embodiments have been shown with only a single PDC tube 103. However, the concept of the present invention is not limited to single PDC tube embodiments. This is shown in FIGS. 9A and 9B.

In FIGS. 9A and 9B, an exemplary embodiment is shown in which a plurality of PDC tubes 903 are positioned in a circular array pattern around a centerline. It is noted that for clarity only 1 of the assembly 900 is shown in FIGS. 9A and 9B. The number of the tubes 903 is a function of performance and design characteristics. Each of the tubes has inlet portions 909 to allow air to flow into the PDC tube 903. Rotating around the tubes 903 is a PDC casing structure 905. The casing structure 905 extends from a central hub 901 around which it rotates. As shown the casing structure 905 is coaxial with a geometric centerline defined by the tubes 903. That is, if the tubes 903 are distributed in a circular pattern the casing structure 905 is centered on the center point of that circle. In an exemplary embodiment, the centerline of the casing structure 905 is parallel with centerlines of the PDC tubes 903. The structure 905 has a plurality of inlet portions 907 through which air flow passes to enter PDC tubes 903 Similar to the operations described above, as the structure 905 is rotated the inlet portions 907 align with the inlet portions 909 to allow the air flow to pass into the tubes 903. Depending on the desired firing frequency of the tubes 903, the structure 905 may have more than one pair of inlet portions 907. If there is a single pair of inlet portions 907, the PDC tubes 903 are fired sequentially around the circular pattern of tubes 903. In another exemplary embodiment, additional pairs of inlet portions 907 are positioned on the structure 905 so as to allow for the filling of more than one tube 903 at one time. In such an embodiment, the pairs of inlet portions 907 are positioned on opposite sides of the structure 905 so that PDC tubes 903 on opposite sides of the assembly 900 are fired simultaneously. This will aid in reducing uneven loading on the structure 905 during operation.

In another exemplary embodiment, the inlet portions 907 are of a size and/or width to allow for the simultaneous filling of at least two adjacent PDC tubes 903 at the same time.

It is noted that the cross-section of the tubes 903 shown in FIG. 9B are at the point of entry of the air flow. In an exemplary embodiment, downstream of the point of entry, the tubes 903 become cylindrical.

Similar to the embodiments described above, the structure 905 can be rotated by any means, such as motors, belts, chains, etc. The present invention is not limited in this regard.

It is noted that although the present invention has been discussed above specifically with respect to aircraft and power generation applications, the present invention is not limited to this and can be in any similar detonation/deflagration device in which the benefits of the present invention are desirable.

While the invention has been described in terms of various specific embodiments, those skilled in the art will recognize that the invention can be practiced with modification within the spirit and scope of the claims.

What is claimed is:

1. A pulse detonation combustor valve assembly, comprising:
a pulse detonation tube having at least two inlet portions; and
a rotating valve portion coupled to and concentric with said at least one pulse detonation tube and adjacent to said at least two inlet portions,
wherein said rotating valve portion has at least two openings which correspond to said at least two inlet portions on said pulse detonation tube during rotation of said rotating valve portion.

2. The pulse detonation combustor valve assembly of claim 1, wherein said rotating valve portion is coaxial with said pulse detonation tube.

3. The pulse detonation combustor valve assembly of claim 1, wherein a centerline of said rotating valve portion is parallel to a centerline of said pulse detonation tube.

4. The pulse detonation combustor valve assembly of claim 1, further comprising a seal portion positioned between said rotating valve portion and pulse detonation tube.

5. The pulse detonation combustor valve assembly of claim 1, wherein said rotating valve portion comprises at least one port which couples a gap between said rotating valve portion and said pulse detonation tube and an air flow duct structure.

6. The pulse detonation combustor valve assembly of claim 1, wherein said pulse detonation tube comprises a bearing portion to which said rotating valve portion is coupled.

7. The pulse detonation combustor valve assembly of claim 1, wherein said pulse detonation tube comprises positioning members which position said rotating valve portion adjacent to said at least two inlet portions.

8. The pulse detonation combustor valve assembly of claim 1, wherein said rotating valve portion comprises at least two fin structures projecting from an outer surface of said rotating valve portion and positioned adjacent to said openings, respectively.

9. The pulse detonation combustor valve assembly of claim 8, wherein said at least two fin structures have a twisted or airfoil shape to provide a rotational force onto said rotating valve portion as an air flow contacts said fin.

10. A pulse detonation combustor valve assembly, comprising:
a pulse detonation tube having at least two inlet portions; and
a rotating valve portion coupled to and concentric with an upstream end of said at least one pulse detonation tube and adjacent to said inlet portions,
wherein said rotating valve portion has at least two openings which correspond to said at least two inlet portions on said pulse detonation tube during rotation of said rotating valve portion, and
wherein said rotating valve portion is coaxial with said pulse detonation tube.

11. The pulse detonation combustor valve assembly of claim 10, wherein a centerline of said rotating valve portion is parallel to a centerline of said pulse detonation tube.

12. The pulse detonation combustor valve assembly of claim 10, further comprising at least one seal portion positioned between said rotating valve portion and pulse detonation tube.

13. The pulse detonation combustor valve assembly of claim 10, wherein said rotating valve portion comprises at least one port which couples a gap between said rotating valve portion and said pulse detonation tube and an air flow duct structure.

14. The pulse detonation combustor valve assembly of claim 10, wherein said pulse detonation tube comprises a bearing portion to which said rotating valve portion is coupled.

15. The pulse detonation combustor valve assembly of claim 10, wherein said pulse detonation tube comprises positioning members which position said rotating valve portion adjacent to said at least one inlet portion.

16. The pulse detonation combustor valve assembly of claim 10, wherein said rotating valve portion comprises at least two fin structures projecting from an outer surface of said rotating valve portion and at least one fin structure is positioned adjacent to each of said openings.

17. The pulse detonation combustor valve assembly of claim 16, wherein at least one of said fin structures has a twisted or airfoil shape to provide a rotational force onto said rotating valve portion as an air flow contacts said fin.

18. A pulse detonation combustor valve assembly, comprising:
a plurality of pulse detonation tubes each having at least one inlet portion; and
a rotating valve portion coupled to and concentric with said plurality of pulse detonation tubes and adjacent to said inlet portions,
wherein said rotating valve portion has at least one opening which corresponds to said at least one inlet portion on each of said pulse detonation tubes during rotation of said rotating valve portion.

19. The pulse detonation combustor valve assembly of claim 18, wherein said rotating valve portion is coaxial with a centerline defined by the plurality of pulse detonation tubes.

20. The pulse detonation combustor valve assembly of claim 18, wherein a centerline of said rotating valve portion is parallel to a centerline of said plurality of pulse detonation tubes.

21. The pulse detonation combustor valve assembly of claim 18, wherein each of said pulse detonation tubes comprises two inlet portions and said rotating valve portion comprises two openings which correspond to said two inlet portions during rotation.

22. The pulse detonation combustor valve assembly of claim 18, wherein said plurality of pulse detonation tubes are oriented in a circular array pattern.
